(19) United States
(12) Patent Application Publication
(10) Pub. No.: US 2014/0232776 A1
(43) Pub. Date: Aug. 21, 2014

(54) METHOD FOR CONTROLLING TENSION IN A WEB

(71) Applicants: Thomas Niertit, (US); Randy E. Armbruster, (US); Lothar J. Schroeder, (US); Scott P. MacKenzie, (US)

(72) Inventors: Thomas Niertit, Webster, NY (US); Randy E. Armbruster, Rochester, NY (US); Lothar J. Schroeder, West Chester, OH (US); Scott P. MacKenzie, Brockport, NY (US)

(21) Appl. No.: 13/768,513

(22) Filed: Feb. 15, 2013

(51) Int. Cl. B41J 15/16

(52) U.S. Cl. CPC B41J 15/16
USPC 347/16

(57) ABSTRACT

A method for controlling tension in a print media in a tension zone of a printing system comprises enabling an active tension control mode until the tension in the print media is in a stable state for a given period of time, and then switching to a synchronized control mode. The tension is monitored to determine if it exceeds a tension inner band but does not exceed a tension outer band while in the synchronized control mode. The speed of drive rollers is adjusted in response to this determination. The tension is also monitored to determine if it exceeds the tension outer band while in the synchronized control mode. The synchronized control mode is disabled in response to this determination and the active tension control mode is enabled. The frequency of speed adjustments is lesser in the synchronized control mode than in the active tension control mode.

### CROSS REFERENCE TO RELATED APPLICATIONS

Reference is made to commonly-assigned, U.S. Application Ser. No. 61/696,848 filed Sep. 5, 2012 and U.S. application Ser. No. ______ (Docket K001255), entitled “TENSION CONTROL IN A WEB TRANSPORT SYSTEM”, filed concurrently herewith.

### FIELD OF THE INVENTION

The present invention generally relates to web transport systems used in printing systems and more particularly to controlling tension in a continuous web in a web transport system.

### BACKGROUND OF THE INVENTION

In high speed inkjet printers, a media transport is used to move a web of print media past a plurality of printheads. The printheads are positioned sequentially along the media path to print each of the plurality of ink colors. The web of print media is kept under tension as it is moved along the media path. Prior art systems, such as the Kodak Versamark 100 series printers, have used a proportional integrate derivative (PID) control algorithm to maintain the tension of the print media as it is moved through the printing system. High quality print requires that the print from each of these printheads be properly registered to each other. It has been found that in some printing applications, depending, for example, on ink coverage levels and the ink and print media types, that the registration of the plurality of printheads along the direction of the media travel can vary unacceptably when using a PID control algorithm to maintain the tension of the print media as it is moved through the printing system. There is a need for an effective method for moving the print media relative to the plurality of printheads to improve the registration of the print from the plurality of printheads.

### SUMMARY OF THE INVENTION

A method for controlling tension in a print media in a tension zone of a continuous web printing system comprises enabling an active tension control mode when initial transport of the print media begins and until the tension in the print media in the tension zone is in a stable state for a given period of time, disabling the active tension control mode and enabling a synchronized control mode after the tension in the print media in the tension zone is in the stable state for the given period of time and adjusting the tension in the print media in the tension zone less frequently than in the active tension control mode, using a processor to monitor the tension in the print media in the tension zone to determine if the tension exceeds a tension inner band and does not exceed a tension outer band while the synchronized control mode is enabled and adjusting a speed of a drive roller in response to the determination that the tension exceeds the tension inner band and does not exceed the tension outer band, and monitoring the tension in the print media in the tension zone to determine if the tension exceeds the tension outer band while the synchronized control mode is enabled, disabling the synchronized control mode in response to the determination that the tension exceeds the tension outer band, and enabling the active tension control mode.

An advantage of the present invention is that it provides better control over adjusting the tension in the print media in the tension zone, thus reducing the amount of stretch in the print media. This allows for better registration of the plurality of printheads in the printing system, resulting in a higher quality print.

### BRIEF DESCRIPTION OF THE DRAWINGS

Embodiments of the invention are better understood with reference to the following drawings. The elements of the drawings are not necessarily to scale relative to each other. Like numbers indicate like parts throughout the views.

FIG. 1 is a graphical illustration of in-track color misalignment;

FIG. 2 is a schematic side view of one example of a continuous web printing system;

FIG. 3 illustrates a top perspective view of one example of a turnover module in an embodiment in accordance with the invention;

FIG. 4 is a flowchart of a method, under the control of a processor shown in FIG. 2, for controlling tension in a continuous web in a web transport system in an embodiment in accordance with the invention; and

FIG. 5 is an example of a plot of the tension and tension control bands in an embodiment in accordance with the invention.

### DETAILED DESCRIPTION OF THE INVENTION

The following terms take the meanings explicitly associated herein, unless the context clearly dictates otherwise. The meaning of “a,” “an,” and “the” includes plural reference, the meaning of “in” includes “in” and “on.” Additionally, directional terms such as “on”, “over”, “top”, “bottom”, “left”, “right” are used with reference to the orientation of the Figure(s) being described. Because components of embodiments of the present invention can be positioned in a number of different orientations, the directional terminology is used for purposes of illustration only and is in no way limiting.

The present description will be directed in particular to elements forming part of, or cooperating more directly with, an apparatus in accordance with the present invention. It is to be understood that elements not specifically shown, labeled, or described can take various forms well known to those skilled in the art. It is to be understood that elements and components can be referred to in singular or plural form, as appropriate, without limiting the scope of the invention. The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention apply to controlling tension in a continuous web in a web transport system as the web transported through a system. The web transport system is adapted to operate in at least two tension control modes, an active tension control mode and a synchronized tension control mode. In the active tension control mode, one or more settings (e.g., speed, position) of a component or components can be adjusted to increase or decrease the tension in the web in a tension zone while the web is transported through the system In the synchronized tension control mode, the operation of tension-adjusting or tension-controlling components are synchronized while the web is transported through a tension zone A tension zone is an area of a web transport system where controlling the tension of a web is desired.

The invention is described herein in conjunction with an inkjet printing system, and the continuous web is the print media. Other embodiments can control tension in different types of webs in different types of systems, such as, for example, a film coating or finishing machine or a packaging machine. With respect to an inkjet printing system, inkjet printing is commonly used for printing on paper, where paper is the print media. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

Many other applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, medical devices, medicinal patches, various circuitry components or structural components. As such, as described herein, the terms “liquid” and “ink” refer to any material that is ejected by a printhead or printhead components described below.

Inkjet printing is a non-contact application of an ink to a print media. The invention described herein is applicable to both drop on demand ink jet (DOD) and continuous ink jet (CIJ) printing technologies. As such, the terms linehead and printhead, as used herein, are intended to be generic and not specific to either technology. Additionally, the terms linehead, printhead, print media, and web can be applied to other nontraditional inkjet applications, such as printing conductors on plastic sheets or medicines or materials on skin. While the description below refers to the printing of multiple color planes by multiple printheads, the invention is not limited to that application. For example multiple printheads can print multiple image planes where the image planes correspond to different laydowns of various substrate coatings and treatments, various medicinal materials, and functional materials useful for forming, for example, various medical devices, medicinal patches, circuitry components or structural components.

As discussed earlier, a web transport system can be used in systems other than inkjet printing systems. As such, the term “web” can be applied to any continuous transport surface or medium that is moved through a system using a web transport system.

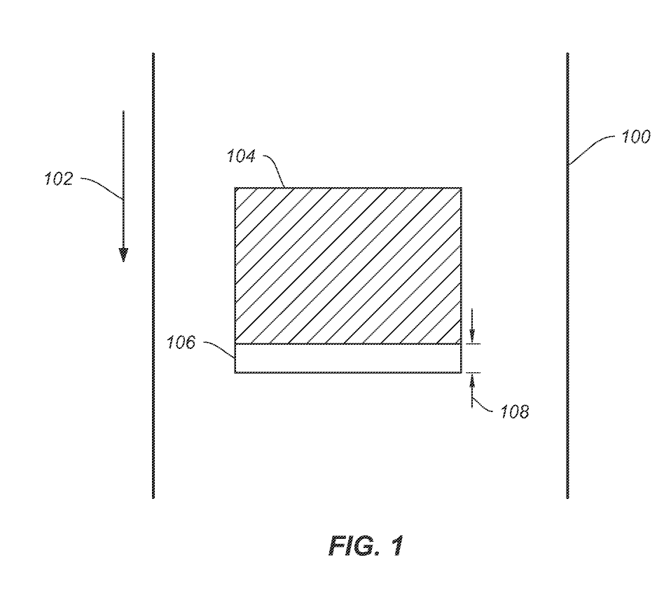

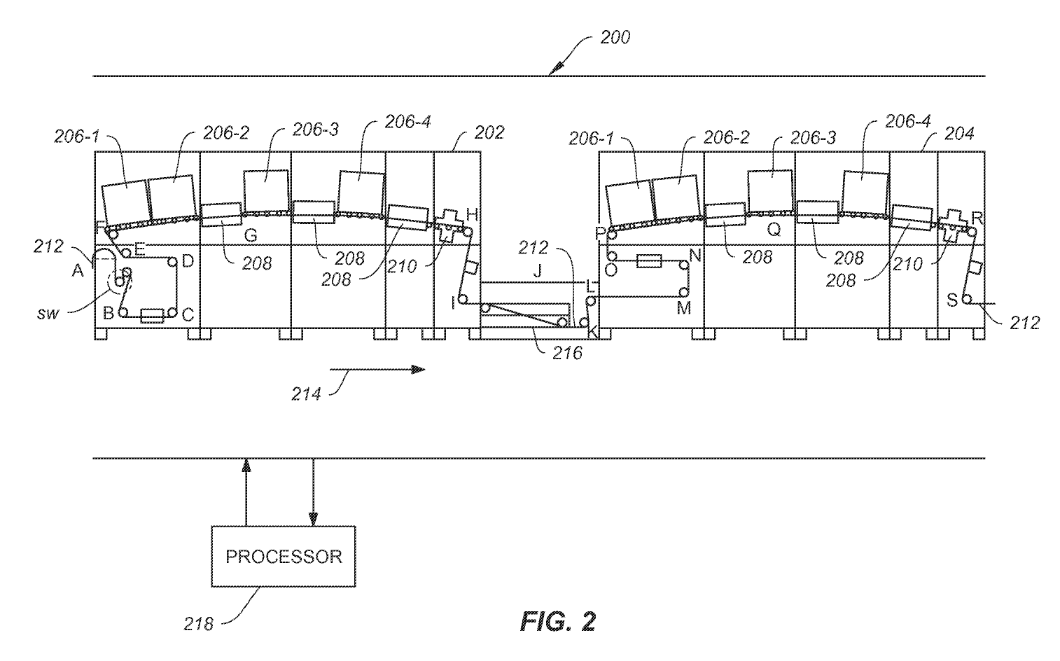

The terms “upstream” and “downstream” are terms of art referring to relative positions along the transport path of the web; points on the transport path move from upstream to downstream. In FIGS. 1 and 2 the web moves from in a direction indicated by feed direction arrow 102. Where they are used, terms such as “first”, “second”, and so on, do not necessarily denote any ordinal or priority relation, but are simply used to more clearly distinguish one element from another.

Referring now to FIG. 1, there is shown a graphical illustration of in-track color misalignment. As a continuous web 100 is transported through a printing system in the feed direction 102, the lineheads (not shown) jet ink onto the web 100. Typically, each linehead jets ink of one color, and the color printed on the web is known as a color plane. The ink colors of all of the lineheads combined form the printed content.

The web 100 can receive a large amount of ink during printing, especially with water-based ink or in high ink laydown regions of the printed content (e.g. a picture with a lot of dense black background). In turn, the aqueous component of the ink can be absorbed into the web and can cause the web to swell and stretch, especially if the web is under tension. Stretch is usually significantly higher in the direction of movement (i.e., the feed or in-track direction) compared to the cross-track direction. Additionally, heat is typically applied at one or more locations in a printing system to dry the ink that has been applied to the continuous web 100. Drying of the web can cause the web to shrink. When the web is heated in between lineheads, regions of the web can be stretched and shrunk one or more times as the web moves through a printing system.

Typically, each linehead jets ink of one color, and the color printed on the web is known as a color plane. The ink colors of all of the lineheads combined form the printed content. Printing with several color planes in which each color record is printed sequentially requires color laydown correlation or registration. Unanticipated or unaccounted for stretch or shrink in the web can cause a loss of color registration and can lead to blurry content or hue degradation.

In the illustrated embodiment of FIG. 1, one color plane 104 has been printed over another color plane 106. The web 100 stretched in the in-track direction between the printing of color plane 106 and color plane 104. The in-track stretch resulted in color misregistration 108 between the two color planes 104, 106. Various aspects of the invention provide a method for controlling tension in a continuous web in a web transport system of a printing system. Controlling the tension in the web can reduce or eliminate color or image misregistration.

FIG. 2 illustrates one example of a continuous web printing system. Printing system 200 includes a first printing module 202 and a second printing module 204, each of which includes lineheads 206, dryers 208, and a quality control sensor 210. Printing system 200 is connected to processing device 218 which controls the operation of the printing system. Each linehead 206 typically includes multiple printheads (not shown) that apply ink or another liquid to the surface of the continuous web of web 212 that is adjacent to the printheads. For descriptive purposes only, the lineheads 206 are labeled a first linehead 206-1, a second linehead 206-2, a third linehead 206-3, and a fourth linehead 206-4. In the illustrated embodiment, each linehead 206-1, 206-2, 206-3, and 206-4 applies a different colored ink to the surface of the web 212 that is adjacent to the lineheads. By way of example only, linehead 206-1 applies cyan colored ink, linehead 206-2 magenta colored ink, linehead 206-3 yellow colored ink, and linehead 206-4 black colored ink.

The first printing module 202 and the second printing module 204 also include a web tension system that serves to physically move the continuous web 212 through the printing system 200 in the feed direction 214 (left to right as shown in the figure). The web 212 enters the first printing module 202 from a source roll (not shown) and the linehead(s) 206 of the first module applies ink to one side of the web 212. As the web 212 feeds into the second printing module 204, a turnover module 216 is adapted to invert or turn over the web 212 so that the linehead(s) 206 of the second printing module 204 can apply ink to the other side of the web 212. The web 212 then exits the second printing module 204 and is collected by a receiving unit (not shown).

First printing module 202 has a support structure that includes a cross-track positioning mechanism (A) for positioning the continuously moving web in the cross-track direction, that is, orthogonal to the feed direction in the plane of travel. In one embodiment, cross-track positioning mechanism (A) is an edge guide for registering an edge of the moving web. An S-wrap device (SW), affixed to the support structure of first module 202, includes structure that sets the tension of the web.

Downstream from the first printing module 202 along the path of the web 212, the second printing module 204 also has a support structure similar to the support structure for first printing module 202. Affixed to the support structure of either or both the first or second module is a kinematic connection mechanism that maintains the kinematic dynamics of the web 212 in traveling from the first printing module 202 into the second printing module 204. Also affixed to the support structure of either the first or second module are one or more angular constraint structures for setting an angular trajectory of the web 212.

Table 1 that follows identifies the lettered components used for web transport as shown in FIG. 2. An edge guide in which the web 212 is pushed laterally so that an edge of the web contacts a stop is provided at (A). The slack web entering the edge guide allows the web 212 to be shifted laterally without interference and without being over-constrained. The S-wrap device (SW) provides stationary curved surfaces over which the continuous web 212 slides during transport. As the web 212 is pulled over these surfaces, the friction of the web 212 across these surfaces produces tension in the web. In one embodiment, the S-wrap device (SW) is adapted to adjust the positional relationship between surfaces, to control the angle of wrap and to allow adjustments in the tension of the web.

TABLE 1
Roller Listing for FIG. 2

| Media | |
|---|---|
| Handling | |
| Component | Type of Component |
| A | Lateral Constraint (edge guide) |
| SW | S-wrap device |
| B | In-Feed Drive Roller |
| C | Castered and Gimbaled Roller |
| D | Gimbaled Load Cell Roller |
| E | Servo-Castered and Gimbaled Roller |
| F | Fixed Roller (tach) |
| G | Rainbow Rollers (Qty = 17, 8 linehead, 6 dryer, 3 QC) |
| H | Servo-Castered and Gimbaled Roller |
| I | Gimbaled Roller |
| J | Turnover Mechanism Drive Roller |
| K | Castered and Gimbaled Roller |
| L | Gimbaled Roller |
| M | Castered and Gimbaled Roller |
| N | Gimbaled Load Cell Roller |
| O | Servo-Castered and Gimbaled Roller |
| P | Fixed Roller (tach) |
| Q | Rainbow Rollers (Qty = 17, 8 linehead, 6 dryer, 3 QC) |
| R | Servo-Castered and Gimbaled Roller |
| S | Out-Feed Drive Roller |

The first angular constraint is provided by in-feed drive roller (B). This is a fixed roller that cooperates with a drive roller (J) in the turnover module 216 and with an out-feed drive roller (N) in second printing module 204 in order to move the web 212 through the printing system 200 with suitable tension in the feed direction 214. The tension provided by the preceding S-wrap device (SW) serves to hold the web 212 against the in-feed drive roll. Angular constraints at subsequent locations downstream along the web 212 are provided by rollers that are gimbaled so as not to impose an angular constraint on the next downstream media span.

Processing device 218 can be connected to various components in the web tension system and the processing device 218 is adapted to transmit data to, and receive data from, the various components. Processing device 218 can be used to control the positions or speeds of some of the components, such as the in feed drive roller and the out feed drive roller. Additionally, processing device 218 can receive tension measurements or data from the load cell roller. Processing device 218 can be connected to components in printing system 200 using any known wired or wireless communication connection. Processing device 218 can be separate from printing system 200 or integrated within printing system 200 or within a component in printing system 200.

Although FIG. 2 depicts each printing module with four lineheads 206, three dryers 208, and one quality control sensor 210, the invention is not limited to this construction. A printing system can include any number of lineheads, any number of dryers, and any number of quality control sensors. The printing system can also include a number of other components, including, but not limited to, web cleaners and web tension sensors. Although the printing system shown in FIG. 2 has the turnover module 216 disposed between the first and second printing modules 202, 204, other printing systems can include the turnover module within one of the printing modules.

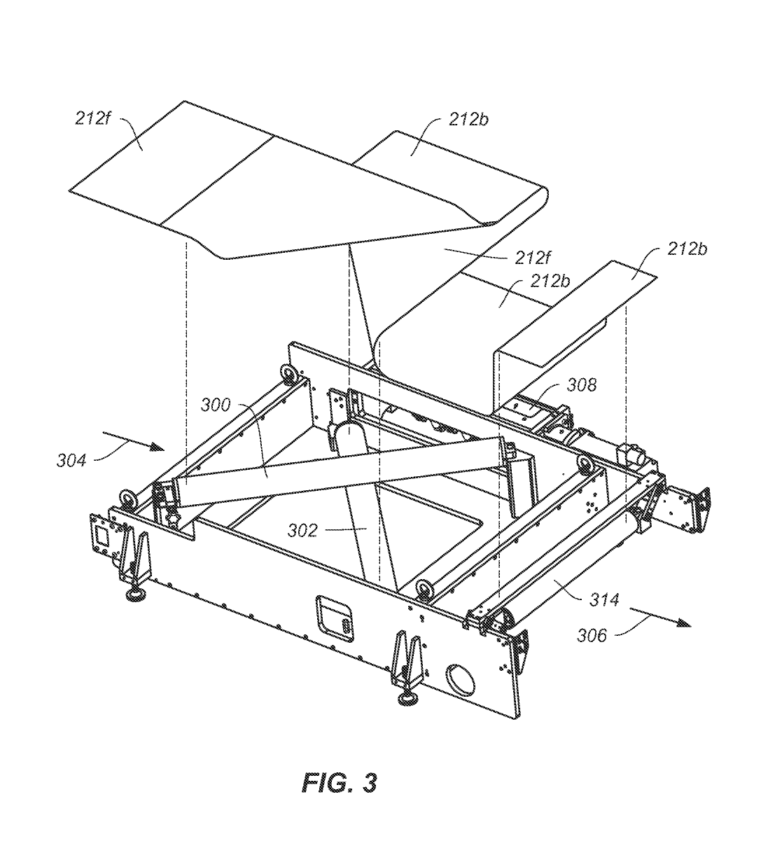

FIG. 3 illustrates a top perspective view of one example of a turnover module in an embodiment of the invention. Turnover module 301 includes stationary turnbars 300, 302 positioned at diagonals to the input path 304 and the output path 306. One or more turnbars can be included in other aspects of the invention. For example, one turnbar can be included in a turnover module that also redirects the web ninety degrees.

In FIG. 3, the front side of the web is identified as 212f and the back side of the web as 212b. The web 212 enters along the input path 304 with ink or another liquid jetted onto a front side of the web 212f. The web 112 then wraps around stationary turnbar 300 and passes to driver roller 308 of the turnover mechanism, where the web wraps around a driver roller 308. The web 212 exits driver roller 308 front side up, as shown in region 310. The web 212 then wraps around stationary turn bar 302 and is directed along the output path 306. The web 212 has now been inverted or turned over (see region 312) and the back side of the web 212b is positioned to receive ink from the linehead(s) in the next printing module (e.g., printing module 204 in FIG. 2). The web 212 passes over bar 314 and exits the turnover module 216 along the output path 306.

The invention employs two different tension control modes, an active tension control mode and a synchronized tension control mode. In the active tension control mode, the speed of one or more rollers is controlled and adjusted to compensate for increasing and decreasing tension in the web. In the embodiment illustrated in FIG. 2, the turnbar driver roller (J) in the turnover module 216 (e.g., turnbar 308 in FIG. 3) is set to turn at a constant speed. Tension is produced in the web in the first printing module 202 with S-wrap device (SW). The speed of the in-feed drive roller (B) is adjusted from the speed of the turnbar driver roller (J) based on the amount of tension measured or sensed in the web in a first tension zone by load cell roller (D). The tension in the web in the first tension zone decreases when the speed of the in-feed drive roller increases. The tension in the web in the first tension zone increases when the speed of the in-feed drive roller decreases. The first tension zone is the zone between the in-feed drive roller (B) and the turnbar driver roller (J) in the turnover module 216. In the active tension control mode, these adjustments to the speed of the in-feed drive roller can be of any magnitude based on the tension difference between the measured tension and the target value for the tension. The adjustments to the speed of the in-feed drive roller B can be made at the maximum update rate or frequency of the control system. In one aspect, the maximum update rate is once every 20 msec. In one aspect, the turnbar roller (J), the in-feed roller (B), and the out-feed rollers (S) are each driven by Bosch Rexroth drive motors. The adjustments comprise sending commands to the drive motor control electronics specifying a new speed. These drives for these drive rollers include encoders which are used by the drive motor control electronics to monitor the speed of these rollers.

In the second printing module 204, the synchronized tension control mode, the speed of the out-feed drive roller (S) is adjusted from the speed of the turnbar driver roller (J) in the turnover module 216 based on the amount of tension measured or sensed in the web in a second tension zone by load cell roller (N). The tension in the web in the second tension zone increases when the speed of the out-feed drive roller increases. The tension in the web in the second tension zone decreases when the speed of the out-feed drive roller decreases. The second tension zone is the zone between the turnbar driver roller (J) in the turnover module 216 and the out-feed drive roller (S).

In synchronized tension control mode, the drive motors are not constantly adjusted to maintain the web tension at the target value. Instead, the speed of the in-feed drive roller (B) is synchronized with the speed of the turnbar drive roller (J) in the turnover module 216 and the speed of the out-feed drive roller (S) is synchronized with the turnbar drive roller (J). That is the operating speeds of the in-feed roller (B) and the out-feed roller (S) are fixed relative to the speed of the turnbar drive roller (J), so that for example the in-feed roller can be driven at a speed 1% slower than the speed of the turnbar roller. In one aspect, the synchronization of the in-feed drive roller with the turnbar drive roller (J) can occur independently of the synchronization of the out-feed drive roller with the turnbar drive roller (J), that is, the in-feed roller (B) can be operated at a speed that is some percent slower than the speed of the turnbar driver roller (J), and the out-feed roller (S) can be operated at another speed that is a different percent faster than the speed of the turnbar driver roller (J).

Compared to the active tension control mode, the synchronized tension control mode yields more consistent stitching and color to color registration. To understand, consider first the case of moving a portion of the media through tension zone without printing on the print media. The non-printed print media is uniform throughout the tension zone, having a uniform elastic modulus. As the print media enters the tension zone between the in-feed roller and the turnbar driver roller (J), the increased tension on the print media causes every portion of the print media in the tension zone to stretch. The amount of stretch is given by T=E*ε where T is the tension, E is the elastic modulus and ε is the amount of stretch or elongation per unit length of the print media. Every length L of print media approaching the in-feed roller is stretched by the tension T in the tension zone to a length L*ε. In a steady state condition, if the print media approaches the in-feed roller at a speed of L/second, then the print media must be approaching the turnbar driver roller (J) at a speed of L*ε/second. The turnbar driver roller (J) must therefore be driven at a speed that is ε times faster than the speed of the in-feed roller to maintain the tension T in the tension zone.

Considering now the case where the print media in the tension zone is printed on by an aqueous ink while the speed of the turnbar driver roller (J) is driven at a speed that is ε times faster than the in-feed roller. Due to this drive speed difference between the in-feed roller and the lumbar driver roller (J), according the analysis above, the stretch of the paper per unit length should be ε. The moistening of the print media in the tension zone causes the modulus of the print media to drop. As the tension is equal to the modulus E*ε, the drop in the elastic modulus of the paper will produce a drop in the print media tension. The synchronized tension control mode, with its fixed relative speeds of the drive rollers at each end of the tension zone, allows the tension of the print media to fluctuate as the print media is selectively wetted by printing, while stretch of the print media is kept fairly constant.

Consider now operating in the active tension control mode, instead of in the synchronized tension control mode. In the active tension control mode the speed of one of the drive rollers is constantly adjusted to maintain a constant tension in the tension zone. With the tension held constant, the fluctuations in elastic modulus of the print media produced by printing on the print media require the elongation ε of the print media to fluctuate. As the color to color registration of the print applied to the tension zone is sensitive to fluctuations in the stretch of the print media not to fluctuations in the tension, the synchronized tension control mode provides more consistent registration than does the active tension control mode.

While synchronized tension control mode provides more consistent color to color registration, as mentioned above, this mode can allow the tension to fluctuate or wander. If the print media tension were to drift too high, there is a risk that the print media could break. If the print media tension were to drift too low, the print media could go slack, at which point crosstrack registration can become inconsistent as the print media no longer tracks through the tension zone consistently. To avoid such excessive drifting of the web tension, the control system can be switched by the processor 218 between active tension control mode and synchronized tension control mode, depending on the difference between the measured and the target tension.

A method for controlling tension in a print media in a tension zone of a continuous web printing system comprises enabling an active tension control mode when initial transport of the print media begins and until the tension in the print media in the tension zone is in a stable state for a given period of time. In the active tension control mode the tension in the print media in the tension zone is constantly adjusted. After the tension in the print media in the tension zone is in the stable state for the given period of time, the processor 218 disables the active tension control mode and enables a synchronized control mode. In the synchronized control mode, the tension in the print media in the tension zone is adjusted less frequently than in the active tension control mode. For example, the tension in the print media in the tension zone can be adjusted once every 20 msec in the active tension control mode, while the tension in the print media in the tension zone can be adjusted once every 1 second in the synchronized control mode.

The tension in the print media in the tension zone is monitored by the processor 218 to determine if the tension exceeds a tension inner band and does not exceed a tension outer band while the synchronized control mode is enabled. It should be clear that the tension can exceed the inner band by crossing to the outside of either the lower or the upper bound of the inner tension band. The speed of one or more drive rollers is adjusted by the processor 218 in response to the determination that the tension exceeds the tension inner band and does not exceed the tension outer band. The tension in the print media in the tension zone is also monitored by the processor 218 to determine if the tension exceeds the tension outer band while the synchronized control mode is enabled. It should be clear that the tension can exceed the outer band by crossing to the outside of either the lower or the upper bound of the outer tension band. The synchronized control mode is disabled by the processor 218 in response to the determination that the tension exceeds the tension outer band and the active tension control mode is once again enabled.

The active tension control mode can be disabled after the tension in the print media in the tension zone returns to the stable state for the given period of time and the synchronized control mode can once again be enabled. This has the advantage of allowing the printer to repeatedly switch between active tension control mode and synchronized control mode in response to the deviation in the tension from the target tension.

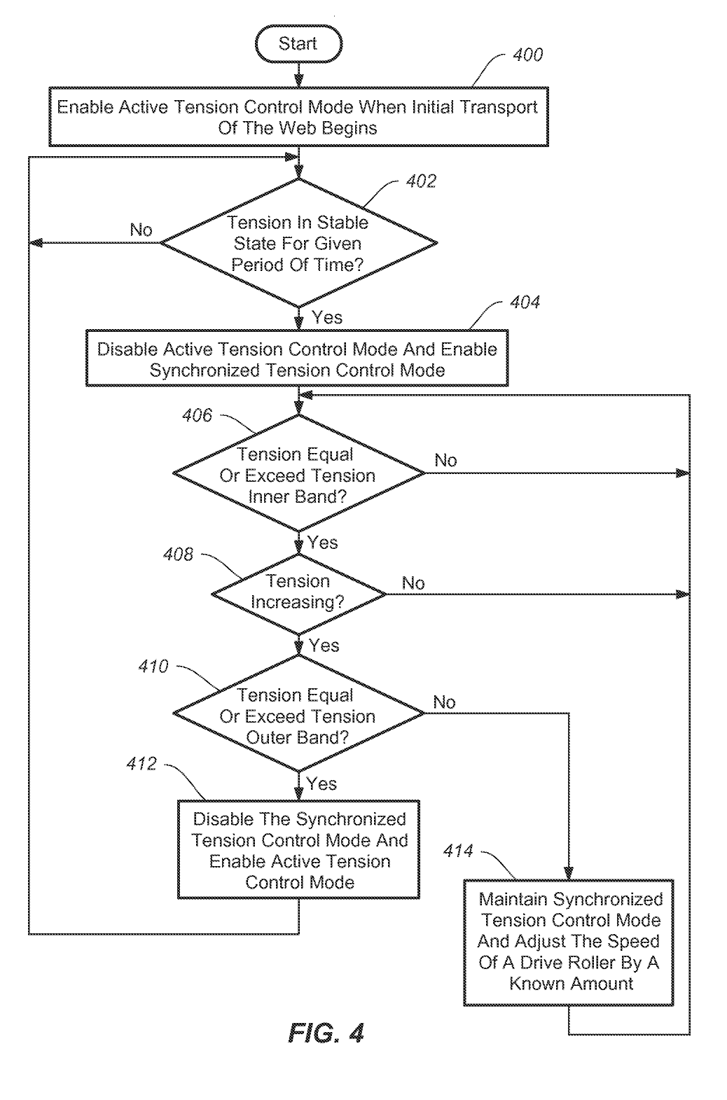

Referring now to FIG. 4, there is shown a flowchart of a method for controlling tension in a continuous web in a web transport system. The method of FIG. 4 can be controlled by the processor 218. As discussed earlier, the web tension system is adapted to enable and disable both an active tension control mode and a synchronized tension control mode. Initially, the active tension control mode is enabled and the synchronized tension control mode disabled when initial transport of the web begins (block 400). For example, the active tension control mode is enabled when a print job begins or when the web transport system is started after a change of web.

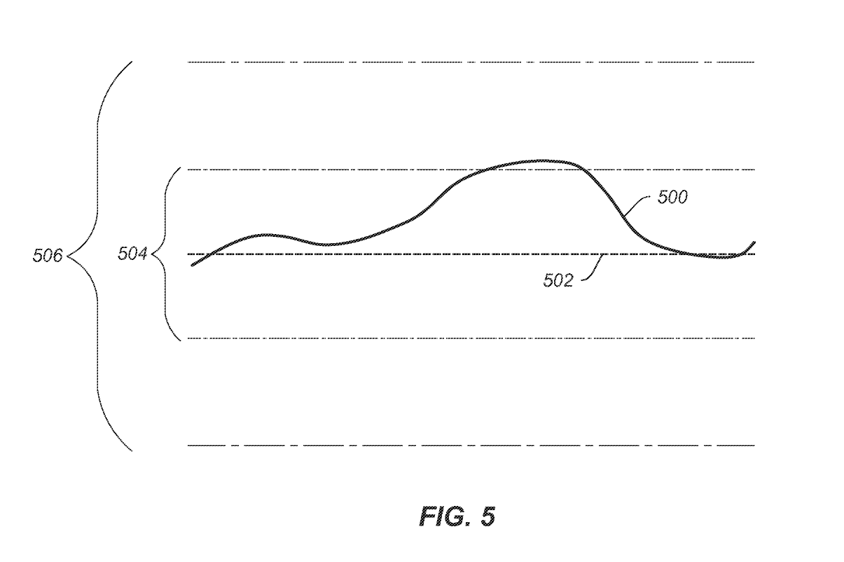

The active tension control mode is in operation until the tension in the web in a tension zone is in a stable state for a given period of time. Typically, the system is in active tension control mode during the ramp up of print speed to the desired printing speed. The use of active tension control during the ramping up and ramping down of the print speed helps to ensure that the web tension stays in the safe range during these periods of rapid speed change to reduce the risk of web breaks or slack web conditions that would adversely affect the tracking of the print media web, and it allows the tension to more quickly approach the desired target tension value. So a determination is made at block 402 as to whether or not the tension in the web in a tension zone is in a stable state. The stable state is described in conjunction with FIG. 5. The tension 500 in the web in a tension zone is actively controlled to reach a target tension 502 or to be within a given tolerance of the target tension 502. By way of example only, the speed of the in-feed drive roller (B) or the speed of the out-feed drive roller (S) is adjusted until the tension in the web reaches the target tension. The adjustments to the speed of the in-feed drive roller (B) and the out-feed roller (S) can be made at the maximum update rate for frequency of the control system. In one aspect, the maximum update rate in the active tension control mode can be once every 20 msec. The adjustments to the speed of the in-feed drive roller (B) and the out-feed drive roller (S) also not limited as to their magnitude, so that the adjustment step size can vary depending in the difference between the tension measured by the load cell and the tension target. While in the active tension control mode, a servo control algorithm can be employed for determining the magnitude of the speed adjustments required for maintaining the web tension at the target value. The servo control algorithm can comprise one of a Proportional-Integrate (PI) control algorithm, a Proportional-Integrate-Derivative (PID) control algorithm, a Proportional-Derivative (PD) control algorithm, or a deadbeat control algorithm.

The stable state is achieved when the tension in the web in a tension zone is stable for a given period of time. “Stable” is defined as having the tension within a tension outer band (e.g., see 506 in FIG. 5), and the given period of time can be, for example, twelve seconds. By way of example only, a processing device (e.g., processing device 218 in FIG. 2) can be used to determine if the tension is in the stable state for the given period of time. Different values for the given period of time can also be employed.

If the tension is not in the stable state, the process waits until the tension in the web in a tension zone is in the stable state for the given amount of time. The method then passes to block 404 where the active tension control mode is disabled and the synchronized tension control mode enabled. The synchronous tension control is initiated with the speeds of the drive rollers set at the final speed values used by the active tension control mode. While in the synchronized tension control mode, a determination is made at block 406 as to whether or not the tension in the web in a tension zone lies inside or outside a tension inner band. By way of example only, a processing device (e.g., processing device 218 in FIG. 2) can be used to determine if the tension lies inside or outside the tension inner band. In response to the determination that the tension exceeds the tension inner band, but does not exceed the tension outer band, the speed of the drive rollers is adjusted by a known amount until the tension in the print media in the tension zone is within the tension inner band. This adjustment can be performed once a known time period. For example, the time period for performing adjustments while in the synchronized control mode can be 1 sec.

One example of a tension inner band 504 is depicted in FIG. 5. In the illustrated embodiment, the tension inner band is +/−5% of the target tension. Other embodiments can determine the boundaries tension inner band differently. For example, the tension inner band can be +/−N, where N is any value; or the tension inner band can be +N and −M, where N and M are any different values. If the tension in the web in a tension zone lies inside the tension inner band, the process can continue in the synchronized tension control mode without any speed adjustments to a drive roller. If the tension in the web in a tension zone does not lie within the tension inner band, the tension either equals one of the boundaries of the tension inner band or it lies outside (exceeds) the tension inner band. A determination is made at block 408 as to whether or not the deviation of the tension in the web from the target is increasing. If the deviation of the tension in the web in a tension zone is not increasing, the method can continue in the synchronized tension control mode without any speed adjustments to a drive roller. The deviation of the measured tension from the target value for the tension is commonly called the tension error.

If the tension error in the web in a tension zone is increasing, a determination is made at block 410 as to whether or not the tension error in the web in a tension zone equals or exceeds a tension outer band. By way of example only, a processing device (e.g., processing device 218 in FIG. 2) can be used to determine if the tension is increasing or if the tension equals or exceeds the tension outer band.

One example of a tension outer band 506 is shown in FIG. 5. In the illustrated embodiment, the tension outer band is +/−11% of the target tension. Other embodiments can determine the tension outer band differently. For example, the tension outer band can be +/−X, where X is any value, or the tension outer band can be +X and −Y, where X and Y are any different values.

If the tension error in the web in a tension zone does not equal or exceed the tension outer band, the process continues at block 414 where the synchronized tension control mode is maintained but the speed of the controlling drive roller for the associated tension zone is adjusted by a known amount. The method then returns to block 406. The synchronized tension control mode continues as long as the tension in the web in a tension zone is within the tension outer band.

The speed of the controlling drive roller for the associated tension zone can be adjusted in incremental steps of a known amount, such as, for example, 0.005% increments. The adjustment of the speed of the controlling drive roller stops when the tension error in the web in a tension zone is within the tension inner band or when the tension error in the web in a tension zone equals or exceeds the tension inner band but the tension error in the web is decreasing. If the tension error in the web in a tension zone equals or exceeds the tension outer band, the process passes to block 412 where the synchronized tension control mode is disabled and the active tension control mode is enabled. The processor 218 then resumes processing at block 402, where the process waits until the tension in the web in a tension zone is in the stable state for the given amount of time. The method can then repeat for the duration of a print job.

In some aspects, the synchronous tension control mode can be deactivated and the active tension control mode can be activated when there is a significant change in the speed of the web of print media, such as when bringing the web to a halt or when changing between a print production speed and another speed that is appropriate for some diagnostic function of the printing system. By switching to the active tension control mode upon initiation of a significant speed change, the tension of the web of print media can be maintained closer to the target tension during the speed change.

The invention has been described in detail with particular reference to certain embodiments thereof, but it will be understood that variations and modifications can be effected within the spirit and scope of the invention. As described earlier, other embodiments in accordance with the invention can control tension in different types of webs transported by different types of web transport systems in different types of systems. And even though specific embodiments of the invention have been described herein, it should be noted that the application is not limited to these embodiments. In particular, any features described with respect to one embodiment may also be used in other embodiments, where compatible. The features of the different embodiments may be exchanged, where compatible.

A method for controlling tension in a print media in a tension zone of a continuous web printing system comprises enabling an active tension control mode when initial transport of the print media begins and until the tension in the print media in the tension zone is in a stable state for a given period of time and disabling the active tension control mode and enabling a synchronized control mode after the tension in the print media in the tension zone is in the stable state for the given period of time.

If the tension in the print media in the tension zone exceeds a tension inner band while in the synchronized control mode, a speed of a drive roller is adjusted by a known amount until the tension in the print media in the tension zone is within the tension inner band. If the tension in the print media in the tension zone exceeds a tension outer band while in the synchronized control mode, the synchronized control mode is disables and the active tension control mode is enabled until the tension in the print media in the tension zone returns to the stable state for the given period of time.

The method described above can further comprise disabling the active tension control mode and enabling the synchronized control mode after the tension in the print media in the tension zone returns to the stable state for the given period of time. In the method described above, adjusting a speed of a drive roller by a known amount until the tension in the print media in the tension zone is within the tension inner band comprises repeatedly adjusting a speed of a drive roller by a known amount until the tension in the print media in the tension zone is within the tension inner band. This adjustment can be performed once a known time period.

When the tension in the print media in the tension zone exceeds a tension inner band and the tension in the print media in the tension zone is increasing while in the synchronized control mode, the speed of a drive roller is adjusted by a known amount until the tension in the print media in the tension zone is within the tension inner band. In various aspects of the present invention, the known amount can be fixed or variable.

### PARTS LIST

100 web
102 feed direction
104 color plane
106 color plane
108 color misregistration
200 printing system
202 printing module
204 printing module
206 linehead
208 dryer
210 quality control sensor
212 web
214 feed direction
216 turnover module
218 processing device
300 turnbar
301 turnover module
302 turnbar
304 input path
306 output path
308 unit
314 bar
400 enable active tension control mode
402 determine if tension in stable state
404 switch to synchronized control mode
406 monitor tension with respect to inner tension band
408 monitor deviation of tension from target
410 monitor tension with respect to outer tension band
412 switch to active tension control mode
414 adjust drive rollers in synchronized control mode
500 plot of tension in web
502 target tension
504 tension inner band
506 tension outer band

1. A method for controlling tension in a print media in a tension zone of a continuous web printing system, comprising:
enabling an active tension control mode when initial transport of the print media begins and until the tension in the print media in the tension zone is in a stable state for a given period of time;
disabling the active tension control mode and enabling a synchronized control mode after the tension in the print media in the tension zone is in the stable state for the given period of time and adjusting the tension in the print media in the tension zone less frequently than in the active tension control mode;
using a processor to monitor the tension in the print media in the tension zone to determine if the tension exceeds a tension inner band and does not exceed a tension outer band while the synchronized control mode is enabled and adjusting a speed of a drive roller in response to the determination that the tension exceeds the tension inner band and does not exceed the tension outer band; and
monitoring the tension in the print media in the tension zone to determine if the tension exceeds the tension outer band while the synchronized control mode is enabled, disabling the synchronized control mode in response to the determination that the tension exceeds the tension outer band, and enabling the active tension control mode.

2. The method according to claim 1, further comprising disabling the active tension control mode and enabling the synchronized control mode after the tension in the print media in the tension zone returns to the stable state for the given period of time.

3. The method according to claim 1, wherein in response to the determination that the tension exceeds the tension inner band and does not exceed the tension outer band, further includes adjusting the speed of the drive roller by a known amount until the tension in the print media in the tension zone is within the tension inner band, the adjustment being performed once a known time period.

4. The method according to claim 1, wherein in response to the determination that the tension exceeds the tension outer band, further including enabling the active tension control mode until the tension in the print media in the tension zone returns to the stable state for the given period of time.

5. The method according to claim 1, wherein the tension outer band is larger than the tension inner band.

6. The method according to claim 1, wherein monitoring the tension in the print media in the tension zone to determine if the tension exceeds a tension inner band while the synchronized control mode is enabled further comprises determining if the deviation of the tension in the web from the target value is increasing and adjusting a speed of a drive roller in response to the determination by a known amount until the tension in the print media in the tension zone is within the tension inner band.

7. The method according to claim 1 wherein the active tension control mode comprises making adjustments to the speed of a drive roller at an update rate that has a period that is less than the known time period for adjustments in the synchronized tension control mode.

8. The method according to claim 1, wherein the active tension control mode comprises using one of a Proportional-Integrate (PI) control algorithm, a Proportional-Integrate-Derivative (PID) control algorithm, a Proportional-Derivative (PD) control algorithm, or a deadbeat control algorithm for determining the magnitude of speed adjustment of a drive roller.

9. The method according to claim 3 further comprising adjusting repeatedly the speed of the drive roller by the known amount until the tension in the print media in the tension zone is within the tension inner band, the adjustment being performed once a known time period.

10. The method according to claim 3, wherein the known amount comprises a fixed known amount.

11. The method according to claim 3, wherein the known amount comprises a variable known amount.

12. The method according to claim 3 wherein the known amount of speed adjustment in the synchronized control mode comprises a known percent change in the speed of a drive roller.

13. The method according to claim 10, wherein the fixed known amount is 1 second.
